(19) United States
(12) Patent Application Publication
(10) Pub. No.: US 2009/0319611 A1
(43) Pub. Date: Dec. 24, 2009

(54) Method and System for Facilitating Exchange of A Data Between Applications Using a Communication Platform

(76) Inventor: Bhavin Turakhia, Mumbai (IN)

Correspondence Address: Daniel M. Gurfinkel;Welsh & Katz, Ltd., 120 S. Riverside Plaza, Chicago, IL, 60606, US

(21) Appl. No.: 12/195,924

(22) Filed: Aug. 21, 2008

(30) Foreign Application Priority Data
Jun. 20, 2008 (IN) 1297/MUM/2008

(51) Int. Cl. G06F 15/16

(52) U.S. Cl. 709/204

(57) ABSTRACT

The present invention relates to method and system for facilitating exchange of a data between a first application and a second application using a communication platform. The communication platform is used by a first user of the first application and a second user of the second application to communicate. The method includes authorizing the first application and the second application to send and receive the data using the communication platform. The data is then transferred from the first application to the second application using the communication platform. For transferring the data, the data is received at the communication platform from the first application. It is identified if the first user has authorized the first application to send the data to the second application. Further, it is verified if the second user has authorized the second application to receive the data from the first application. If both the applications are authorized, the data is sent to the second application by the communication platform.

### FIELD OF THE INVENTION

The invention relates generally to exchanging data and specifically, to method and system for facilitating exchange of a data between applications using a communication platform.

### BACKGROUND OF THE INVENTION

Everyone today is acquainted with communication platforms, such as Instant Messaging (IM) systems like Skype, MSN, Yahoo etc, or Social Networking applications, or Voice over Internet Protocol (VoIP) platforms or any such other messaging platforms. A communication platform allows a user to send instant messages, voice and video to other users of the communication platform. A communication platform framework manages presence information, presence subscription, message security, blocking, privacy, authentication, buddy lists etc. However communication platforms are, generally, closed and are only used to send their own data packets from one user to another.

For enabling communication and data sharing between any other applications of a user across computing devices, these applications need to write their own proprietary messaging framework.

Hence there is a need to utilize an existing communication platform for enabling exchange of data between two or more applications residing on one or more computing devices.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

FIG. 1 illustrates a block diagram of an exemplary environment for facilitating exchange of a data between applications using a communication platform in accordance with various embodiments of the present invention.

FIG. 2 illustrates a flow diagram of a method for facilitating exchange of a data between applications using a communication platform in accordance with an embodiment of the present invention.

FIG. 3 illustrates a block diagram of a system for facilitating exchange of a data between applications using a communication platform in accordance with an embodiment of the present invention.

### DETAILED DESCRIPTION OF THE INVENTION

Before describing in detail embodiments that are in accordance with the invention, it should be observed that the embodiments reside primarily in combinations of method steps and apparatus components related to facilitating exchange of a data between applications using a communication platform. Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of facilitating exchange of a data between applications using a communication platform described herein. The non-processor circuits may include, but are not limited to, a radio receiver, a radio transmitter, signal drivers, clock circuits, power source circuits, and user input devices. As such, these functions may be interpreted as steps of a method and system for facilitating exchange of a data between applications using a communication platform. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention relates generally to a framework, whereby, a communication platform can be extended as a messaging bus for other applications of users of the communication platform, thus serving as an underlying message exchange platform between applications that had no other way of communicating with one another. The applications can be hosted on two or more separate computing devices. Those skilled in the art will realize that this sort of a message bus can be very useful for collaboration applications such as office suites, gaming and other such applications which require instances of applications of users to interact with one another. The present invention proposes a framework that can be implemented by an existing communication platform provider, such as, but not limited to, an Instant Messaging (IM) provider, or a VoIP provider, to enable application developers to use that provider's framework, infrastructure, user base, systems etc. to exchange messages between applications across users of different computing devices.

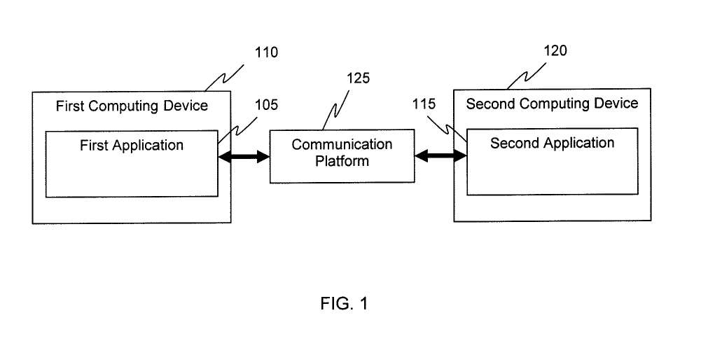

Referring now to FIG. 1, a block diagram of an exemplary environment for facilitating exchange of a data between applications using a communication platform is shown in accordance with various embodiments of the present invention. In one embodiment, a first application 105 can be hosted on a first computing device 110 of a first user and a second application 115 can be hosted on a second computing device 120 of a second user. First application 105 may need to send some data to second application 115. For instance, if first application 105 and second application 115 are office suites, they may need to interact with each other to facilitate collaborative editing. First application 105 and second application 115 can also be gaming applications. Broadly, first application 105 and second application 115 can be any application, such as, but not limited to web applications or applications installed on first computing device 110 and second computing device 120, that require interaction with other applications. In another embodiment, first application 105 and second application 115 maybe web applications deployed on a web server.

Moreover, first application 105 and second application 115 may be different applications or can be instances of the same application. Also, first application 105 and second application 115 may be hosted on a same computing device or different computing devices.

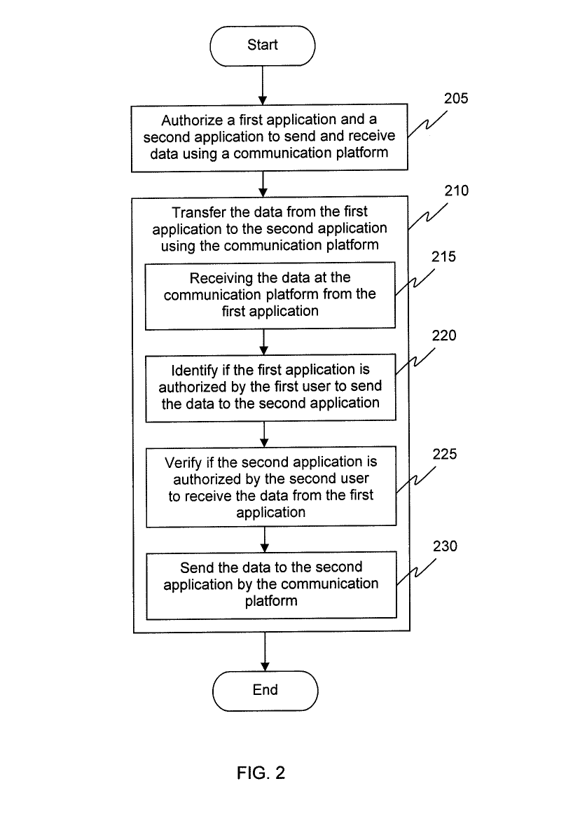

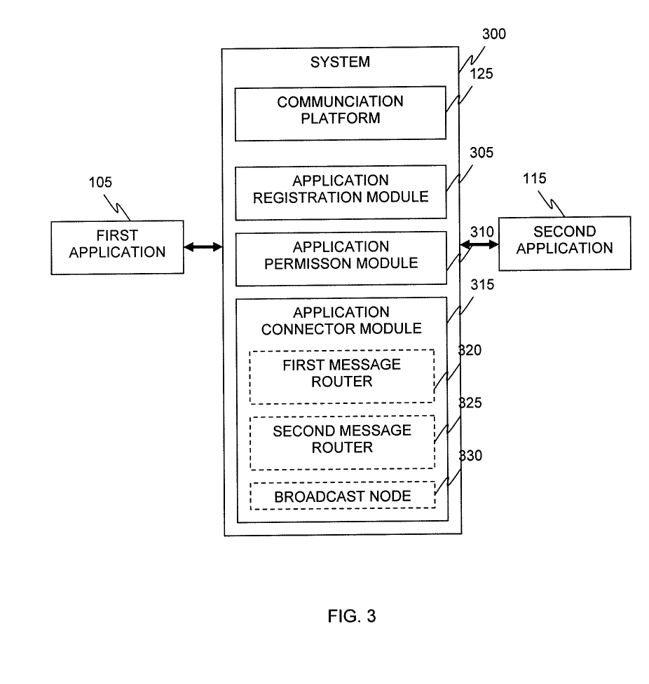

In accordance with the present invention, first application 105 and second application 115 can exchange data using a communication platform 125. Communication platform 125 can be any existing system that enables exchange of data, such as, but not limited to, an IM system, a VoIP system, a P2P platform. Further, although FIG. 1 depicts interaction between two applications, those skilled in the art will realize that the present invention can facilitate a plurality of applications of a plurality of users to exchange data with each other simultaneously. The method and system for facilitating first application 105 and second application 115 to exchange data using communication platform 125 is described in detail in conjunction with FIG. 2 and FIG. 3, respectively.

Turning now to FIG. 2, a flow diagram of a method for facilitating exchange of a data between applications using communication platform 125 is shown in accordance with an embodiment of the present invention. Before using communication platform 125 for exchanging the data, first application 105 and second application 115 may be required to be authorized, at step 205, to send and receive the data.

In an embodiment of the present invention, first application 105 and second application 115 can send an authorization request through communication platform 125 to the first user and/or the second user. The authorization request can consist of a permission to send and receive the data through communication platform 125. Communication platform 125 can then obtain and store the authorization response received from the first user and the second user.

The authorization response can include a first authorization, a second authorization, a third authorization, a fourth authorization or a fifth authorization. The first authorization permits sending and receiving the data between first application 105 and second application 115 only, which means that if any other application of the first user and/or the second user wish to exchange data with first application 105 or second application 115, that new application may need to obtain separate authorization from the first user and/or the second user. The second authorization permits sending and receiving the data between first application 105 and a plurality of applications of the second user. The third authorization permits sending and receiving the data between first application 105 and a plurality of applications of a plurality of users. The fourth authorization permits sending and receiving the data between a plurality of applications of the first user and second application 115. The fifth authorization permits sending and receiving the data between a plurality of applications of a plurality of users and second application 115. The authorization response is stored by communication platform 125. Any of these authorizations can be temporary such that they expire within a certain time period after which the authorization needs to be re-obtained, or permanent such that the authorization never expires.

In another embodiment of the present invention, first application 105 and second application 115 can send an authorization request through communication platform 125 to the first user and/or the second user. The authorization request can consist of a permission to fetch a first user information and a second user information from the communication platform. The communication platform 125 can then obtain and store the authorization response received from the first user and/or the second user.

The first user information can include a contact information of the first user, a demographic information of the first user such as the first user's location etc, one or more first contacts belonging to the contact list of the first user, a device information of the first user, a presence information for the one or more first contacts, one or more second contacts belonging to the contact list of the one or more first contacts, and one or more applications being used by the one or more first contacts and/or the one or more second contacts. Similarly, the second user information includes a contact information of the second user, a demographic information of the second user, such as the second user's location, one or more third contacts belonging to the contact list of the second user, a device information of the second user, a presence information for the one or more third contacts, one or more fourth contacts belonging to the contact list of the one or more third contacts, and one or more applications being used by the one or more third contacts and/or the one or more fourth contacts.

The authorization response in this case can include a first specific authorization, a second specific authorization, a third specific authorization or a fourth specific authorization. The first specific authorization permits the first application to obtain one or more of the first user information and the second user information. The second specific authorization permits the second application to obtain one or more of the first user information and the second user information. The third specific authorization permits the first application to obtain a subset of the first user information and/or the second user information. The fourth specific authorization permits the second application to obtain a subset of the first user information and/or the second user information. Any of these authorizations can be temporary such that they expire within a certain time period after which the authorization needs to be re-obtained, or permanent such that the authorization never expires.

At step 205, for the authorizations described above, first application 105 and second application 115 may need to be identified. For this purpose, a unique first identifier can be assigned for first application 105 and a unique second identifier can be assigned for second application 115 by communication platform 125.

First application 105 and second application 115 may need to establish a connection with communication platform 125 for obtaining the authorization and subsequently using communication platform 125 to exchange the data and to obtain the first user information and/or the second user information. This connection can be, but is not limited to, a network socket connection, a file socket connection, an HyperText Transfer Protocol (HTTP) connection, a User Datagram Protocol (UDP) connection, and an Extensible Messaging and Presence Protocol (XMPP) connection.

To be able to establish the connection with communication platform 125, a connectivity information of one or more communication platform components of communication platform 125 can be obtained. The connectivity information can include, but is not limited to, a network address of the one or more communication platform components, a port number of the one or more communication platform components, a hostname of the one or more communication platform components, an Internet Protocol (IP) address of the one or more communication platform components, an Application Programming Interface (API) exposed by the one or more communication platform components, a Universal Resource Indicator (URI) of the one or more communication platform components, and a callback method exposed by the one or more communication platform components. The one or more communication platform components can include, but is not limited to, an IM client, an IM server, a Voice over Internet Protocol (VoIP) client, a VoIP Server, a desktop client software, a mobile client software, a server software, a Simple Traversal of UDP through NATs (Network Address Translation) (STUN) server, a Traversal Using Relay NAT (TURN) server, a relay server, a Publish-Subscribe (pubsub) service, an Extensible Messaging and Presence Protocol (XMPP) Server, an Extensible Messaging and Presence Protocol (XMPP) client, and a Peer To Peer (P2P) client.

Once first application 105 and second application 115 are authorized to exchange the data using communication platform 125, the data can be transferred to second application 115, at step 210. The first user information and/or the second user information may be needed by first application 105 and/or second application 115 to initiate the transfer of the data.

For transferring the data, communication platform 125 receives the data from first application 105 at step 215. First application 105 can send the data to communication platform 125 by making a call to an API provided by communication platform 125. The data can also be obtained by communication platform 125 over a file or socket connection established by first application 105. Alternatively, the data can be queued in a shared message queue from where communication platform 125 may dequeue the same.

It is then verified, by communication platform 125 at step 220, if the first user has authorized first application 105 to send the data to second application 115. This can be checked using the authorization response obtained earlier from the first user. If a first user authorization, granting first application 105 authorization to send the data to second application 115, does not exist, the first user may be prompted by communication platform 125 to provide the first user authorization.

The data is then transferred within communication platform 125 towards the second user, where it is similarly verified, at step 225, by communication platform 125, if the second user has authorized second application 215 to receive data from first application 105. This can be checked using the authorization response obtained earlier from the second user. If a second user authorization, granting second application 115 to receive the data from first application 105, does not exist, the second user may be prompted by communication platform 125 to provide the second user authorization. Also, if second application 115 is not present or running, the second user may be prompted to install or start second application 115.

Eventually, communication platform 125 sends the data to second application 115. Communication platform 125 can send the data to second application 115 by making a call to an API callback function provided by the second application 115. The API callback function is provided by second application 115 to communication platform 125. Alternately, the data can be sent over a file or socket connection established with second application 125. The data may also be enqueued in a shared message queue from which it can be dequeued by second application 115. In an embodiment of the present invention, the data may be encrypted by communication platform 125 while transmitting it from the first user to the second user. Those skilled in the art will realize that the encryption may be to ensure secure transmission of the data.

In an embodiment of the present invention, a broadcast node is used to broadcast the data to a plurality of applications. Thus, when first application 105 wants to transfer data to a plurality of applications of a plurality of users, for instance in case of gaming, first application 105 can send the data to the broadcast node. The broadcast node can then broadcast the data to the plurality of applications of the plurality of users through communication platform 125. The broadcast node maybe a component of communication platform 125 being installed on the first computing device of the first user or any one or more of the plurality of users, or an independent server. Communication platform 125 may verify that first application 105 is authorized to send the data, and that the plurality of applications are authorized to receive the data by the first user and the plurality of users, respectively, via communication platform 125.

Turning now to FIG. 3, a block diagram of a system 300 for facilitating exchange of a data between applications using communication platform 125 is shown in accordance with an embodiment of the present invention. System 300 can include communication platform 125, an application registration module 305, an application permission module 310 and an application connector module 315. In an embodiment of the present invention, application connector module 315 can further include a first message router 320 and a second message router 325.

In an embodiment of the present invention, one or more of application registration module 305, application permission module 310, application connector module 315, first message router 320 and second message router 325 may be a part of communication platform 125 or an independent device. Each of the system modules is described in detail below.

In an embodiment of the present invention, communication platform 125 can further comprise of various components including but not limited to an IM client, an IM server, a Voice over Internet Protocol (VoIP) client, a VoIP Server, a desktop client software, a mobile client software, a server software, a Simple Traversal of UDP through NATs (Network Address Translation) (STUN) server, a Traversal Using Relay NAT (TURN) server, a relay server, a Publish-Subscribe (pubsub) service, an Extensible Messaging and Presence Protocol (XMPP) Server, an Extensible Messaging and Presence Protocol (XMPP) client, and/or a Peer To Peer (P2P) client

In order to use communication platform 125 for exchanging the data, first application 105 and second application 115 register with application registration module 305. During the registration, application registration module 305 can allocate a unique first identifier to first application 105 and a unique second identifier to second application 115. First application 105 can be uniquely identified at communication platform 125 using the unique first identifier. Similarly, second application 115 can be uniquely identified at communication platform 125 using the unique second identifier.

Further, in an embodiment, application registration module 305 may be configured to provide a connectivity information of one or more communication platform components of communication platform 125 to first application 105 and second application 115. The connectivity information can be useful for connecting first application 105 and/or second application 115 to the one or more components of communication platform 125.

First application 105 and second application 115 can then request for authorization to exchange data and to obtain the first user information and/or the second user information from the first user and/or the second user via application permission module 310. For authorizing first application 105, application permission module 310 receives an authorization request from first application 105 or second application 115. The authorization request can include a permission to obtain a first user information and a second user information. Alternately, the authorization request can include a permission to send and receive the data through communication platform 125.

Application permission module 310 can, in turn, send the authorization request to the first user or the second user. Application permission module 310 can then obtain and store the authorization responses received from the first user or the second user. Authorization responses are explained in detail in conjunction with FIG. 2 above.

Once first application 105 and second application 115 are authorized by application permission module 310, first application 105 and second application 115 can connect to application connector module 315. This connection may be an HTTP connection, an XMPP connection, a persistent TCP/IP connection, or a UDP connection or such other socket connection.

Upon connecting to application connector module 315, first application 105 and second application 115 can fetch one or more of the first user information and the second user information as described in conjunction with FIG. 2 above. Further, the first user information and/or the second user information maybe obtained in a push manner (pushed by application connector module 315) or a pull model (pulled by first application 105 or second application 115 by sending a request to application connector module 315). Further, application connector module 315 can verify that first application 105 and second application 115 are indeed authorized by the first user and the second user, respectively, to obtain this information by checking with application permissions module 310.

In an embodiment of the present invention, first application 105 or second application 115 can also initiate sending data to each other or to other applications registered at application registration module 305 through communication platform 125. Application connector module 315 is configured to transfer the data from first application 105 and second application 115 to each other and to other applications, using communication platform 125. First message router 320 can receive the data from first application 105. First application 105 can send the data to first message router 320 by making a call to an API of first message router 320. The data may also be obtained over a connection or first application 105 may queue the data in a shared message queue.

First message router 320, then, identifies if the first user has authorized first application 105 to send the data to second application 115, by checking with application permission module 310. If the first user has not authorized first application 105 to send the data, application permission module 310 can prompt the first user to provide the authorization. However, if first application 105 is authorized to send the data, first message router forwards the data to second message router 325.

Second message router 325 receives the data from first message router 320 through communication platform 125. Second message router 325 then verifies if the second user has authorized second application 115 to receive the data from first application 105. If the second user has not authorized second application 115 to receive the data, application permission module 310 can prompt the second user to provide the authorization. However, if second application 115 is authorized, then second message router 325 sends the data to second application 115. Second message router 325 can send the data to second application 115 by making a call to an API function of second application 115. The data may also be sent over a connection or second message router 325 can queue the data in a shared message queue. If second application 115 is absent, application registration module 305 can prompt the second user to install or run second application 115.

In an embodiment of the present invention, application connector module 315 includes a broadcast node 330 to enable first application 105 to transfer the data to a plurality of applications through communication platform 125. If the first user authorizes first application 105 to broadcast the data to a plurality of users, broadcast node 330 receives the data from first message router 320. Broadcast node 330 then broadcasts the data to a plurality of second message routers corresponding to a plurality of users. The plurality of second message routers, then, sends the data to the plurality of applications. Second application 115 can belong to the plurality of applications and the second user can belong to the plurality of users. Each of the plurality of applications may be required to be registered with application registration module 305 and may need to have the appropriate authorizations in order to receive the broadcast of the data.

Various embodiments of the present invention allow applications to exchange data with other applications using a communication platform such as an IM system, or a VoIP system etc without requiring to build a proprietary platform for exchanging messages. Moreover, the present invention also allows for the communication platforms used by users of the applications to be different. Further, the applications exchanging messages are separate from or independent of the communication platform.

The above mentioned advantages are merely exemplary and should not be restricted to the ones specified. Those skilled in the art shall appreciate that the advantages may be several and all such advantages are within the scope of the present invention.

1. A method for facilitating exchange of a data between a first application and a second application using a communication platform, wherein the communication platform is used by a first user and a second user, the method comprising:
authorizing the first application and the second application to send and receive the data using the communication platform, wherein the first application is being used by the first user and the second application is being used by the second user, wherein the first application and the second application are different from the communication platform;
transferring the data from the first application to the second application using the communication platform, the transferring step comprising:
receiving the data at the communication platform from the first application;
identifying if the first application is authorized to send the data to the second application by the first user;
verifying if the second application is authorized to receive the data from the first application by the second user; and
sending the data to the second application by the communication platform.

2. The method of claim 1, wherein the first application sends the data to a plurality of applications of a plurality of users through the communication platform, the second application belonging to the plurality of applications and the second user belonging to the plurality of users.

3. The method of claim 2, wherein the receiving step comprises receiving the data at a broadcast node, wherein the broadcast node is a part of the communication platform.

4. The method of claim 3, wherein the sending step comprises broadcasting the data by the broadcast node to the plurality of applications through the communication platform, wherein the plurality of applications are verified to be authorized to receive the data from the first application by the plurality of users.

5. The method of claim 1, wherein one or more of the first application and the second application establish a connection to the communication platform.

6. The method of claim 5, wherein a connectivity information of one or more communication platform components is obtained to enable one or more of the first application and the second application to connect to the communication platform, the communication platform comprising the one or more communication platform components.

7. The method of claim 6, wherein the connectivity information comprises one or more of a network address of the one or more communication platform components, a port number of the one or more communication platform components, a hostname of the one or more communication platform components, an Internet Protocol (IP) address of the one or more communication platform components, an Application Programming Interface (API) exposed by the one or more communication platform components, a Universal resource Indicator (URI) of the one or more communication platform components, and a callback method exposed by the one or more communication platform components.

8. The method of claim 6, wherein the one or more communication platform components comprises one or more of an IM client, an IM server, a Voice over Internet Protocol (VoIP) client, a VoIP Server, a desktop client software, a mobile client software, a server software, a Simple Traversal of UDP through NATs (Network Address Translation) (STUN) server, a Traversal Using Relay NAT (TURN) server, a relay server, a Publish-Subscribe (pubsub) service, an Extensible Messaging and Presence Protocol (XMPP) server, an Extensible Messaging and Presence Protocol (XMPP) client, and a Peer To Peer (P2P) client.

9. The method of claim 5, wherein the connection is one or more of a network socket connection, a file socket connection, a HyperText Transfer Protocol (HTTP) connection, a User Datagram Protocol (UDP) connection, and an Extensible Messaging and Presence Protocol (XMPP) connection.

10. The method of claim 1, wherein one or more of the first user and the second user authorize one or more of the first application and the second application to obtain one or more of a first user information and a second user information from the communication platform

11. The method of claim 10, wherein the first application obtains one or more of the first user information and the second user information from the communication platform.

12. The method of claim 10, wherein the authorizing step comprises:
sending an authorization request by one or more of the first application and the second application through the communication platform to one or more of the first user and the second user, the authorization request comprising a permission to obtain one or more of the first user information and the second user information; and
obtaining and storing an authorization response.

13. The method of claim 12, wherein the authorization response comprises one or more of a first specific authorization, a second specific authorization, a third specific authorization, and a fourth specific authorization, the first specific authorization permitting the first application to obtain one or more of the first user information and the second user information, the second specific authorization permitting the second application to obtain one or more of the first user information and the second user information, the third specific authorization permitting the first application to obtain a subset of one or more of the first user information and the second user information, the fourth specific authorization permitting the second application to obtain a subset of one or more of the first user information and the second user information.

14. The method of claim 13, wherein one or more of the first specific authorization, the second specific authorization, the third specific authorization, and the fourth specific authorization are one or more of a temporary authorization and a permanent authorization.

15. The method of claim 10, wherein the authorizing step uses one or more of a unique first identifier and a unique second identifier, wherein the unique first identifier is assigned for the first application, and the unique second identifier is assigned for the second application.

16. The method of claim 10, wherein the first user information comprises a contact information of the first user, a demographic information of the first user, a profile information of the first user, one or more first contacts belonging to a contact list of the first user, a device information of the first user, a presence information for the one or more first contacts, a one or more second contacts belonging to a contact list of the one or more first contacts, and one or more applications being used by one or more of the one or more first contacts and the one or more second contacts, and the second user information comprises a contact information of the second user, a demographic information of the second user, a profile information of the second user, one or more third contacts belonging to a contact list of the second user, a device information of the second user, a presence information for the one or more third contacts, one or more fourth contacts belonging to a contact list of the one or more third contacts, and one or more applications being used by one or more of the one or more third contacts and the one or more fourth contacts.

17. The method of claim 1, wherein the transferring step uses one or more of the first user information and the second user information.

18. The method of claim 1, wherein the authorizing step comprises:
sending an authorization request by one or more of the first application and the second application through the communication platform to one or more of the first user and the second user, the authorization request comprising a permission to send and receive the data through the communication platform; and
obtaining and storing an authorization response.

19. The method of claim 18, wherein the authorization response comprises one or more of a first authorization, a second authorization, a third authorization, a fourth authorization, and a fifth authorization, the first authorization permitting sending and receiving the data between the first application and the second application only, the second authorization permitting sending and receiving the data between the first application and a plurality of applications of the second user, the third authorization permitting sending and receiving the data between the first application and a plurality of applications of a plurality of users, the fourth authorization permitting sending and receiving the data between a plurality of applications of the first user and the second application, the fifth authorization permitting sending and receiving the data between a plurality of applications of a plurality of users and the second application.

20. The method of claim 19, wherein one or more of the first authorization, the second authorization, the third authorization, the fourth authorization, and the fifth authorization are one or more of a temporary authorization and a permanent authorization

21. The method of claim 1, wherein the authorizing step uses one or more of a unique first identifier and a unique second identifier, wherein the unique first identifier is assigned for the first application, and the unique second identifier is assigned for the second application.

22. The method of claim 1, wherein the first application is hosted on a first computing device of the first user and the second application is hosted on a second computing device of the second user.

23. The method of claim 1, wherein the first application is one or more of a web application and an application installed on the first users computing device and the second application is one or more of a web application and an application installed on the second users computing device.

24. The method of claim 1, wherein the receiving step comprises performing one or more of:
making a call to an API;
obtaining the data over a connection; and
putting the data in a first shared message queue.

25. The method of claim 1, wherein the sending step comprises performing one or more of:
making a call to a first API function of the second application;
sending the data over a connection; and
putting the data in a second shared message queue.

26. The method of claim 25, wherein the first API function is provided by the second application to the communication platform.

27. The method of claim 1, wherein in the identifying step, if a first user authorization is absent, the first user is prompted to provide the first user authorization.

28. The method of claim 1, wherein in the verifying step, if a second user authorization is absent, the second user is prompted to provide the second user authorization.

29. The method of claim 1, wherein in the verifying step, if the second application is absent on a second computing device, the second user is prompted to install the second application, wherein the second computing device belongs to the second user.

30. The method of claim 1, wherein the data is encrypted by the communication platform.

31. The method of claim 1, wherein the first application and the second application are one or more of instances of the same application and different applications.

32. A system for facilitating exchange of a data between a first application and a second application, the system comprising:
a communication platform, wherein the communication platform enables the first application and the second application to exchange the data, a first user and a second user using the communication platform for communication, the first user using the first application and the second user using the second application;
an application registration module, the first application and the second application registering with the application registration module;
an application permission module, wherein the application permission module is configured to:
authorize the first application and the second application to send and receive the data using the communication platform, wherein the first application and the second application are different from the communication platform; and
an application connector module, the application connector module is configured to transfer the data from the first application to the second application using the communication platform.

33. The system of claim 32, wherein the application registration module is configured to provide a connectivity information of one or more communication platform components to the first application and the second application, to enable one or more of the first application and the second application to connect to the communication platform, the communication platform comprising the one or more communication platform components.

34. The system of claim 33, wherein the one or more communication platform components comprises one or more of an IM client, an IM server, a VoIP client, a VoIP Server, a desktop client software, a mobile client software, a server software, a STUN server, a TURN server, a relay server, a Publish-Subscribe (pubsub) service, an Extensible Messaging and Presence Protocol (XMPP) server, an Extensible Messaging and Presence Protocol (XMPP) client, and a P2P client.

35. The system of claim 32, wherein the application registration module allocates a unique first identifier to the first application and a unique second identifier to the second application, wherein the first application uses the unique first identifier for identification on the communication platform and the second application uses the unique second identifier for identification on the communication platform.

36. The system of claim 32, wherein the application permission module is configured to:
receive an authorization request from one or more of the first application and the second application, the authorization request comprising a permission to one or more of obtain the first user information and the second user information and send and receive the data through the communication platform;
send the authorization request to one or more of the first user and the second user; and
obtain and store an authorization response.

37. The system of claim 36, wherein the application permission module uses one or more of the unique first identifier and the unique second identifier to send the authorization request.

38. The system of claim 32, wherein the application connector module comprises:
a first message router, the first message router configured to:
receive the data from the first application;
identify if first application is authorized to send the data to the second application by the first user;
forward the data to a second message router, through the communication platform if the first application is authorized to send the data to the second application; and
a second message router, the second message router configured to:
receive the data from the first message router through the communication platform;
verify if the second application is authorized to receive the data from the first application by the second user; and
send the data to the second application.

39. The system of claim 38, wherein the first application sends the data to the first message router by performing one or more of:
making a call to an API of the first message router;
obtaining the data over a connection; and
queuing the data in a first shared message queue.

40. The system of claim 38, wherein the second message router sends the data to the second application by performing one or more of:
making a call to a first API function of the second application;
sending the data over a connection; and
queuing the data in a second shared message queue.

41. The system of claim 38, wherein if a first user authorization is absent, the application permission module prompts the first user to provide the first user authorization.

42. The system of claim 38, wherein if a second user authorization is absent, the application permission module prompts the second user to provide the second user authorization.

43. The system of claim 38, wherein the application registration module, the application connector module, the application permissions module, the first message router and the second message router are one or more of a part of the communication platform, and one or more independent entities.

44. The system of claim 38, wherein the application connector comprises a broadcast node, the broadcast node configured to:
receive the data from the first message router; and
broadcast the data to a plurality of second message routers, the plurality of second message routers corresponding to a plurality of users of a plurality of applications, the second application belonging to the plurality of applications and the second user belonging to the plurality of users.

45. The system of claim 44, wherein the plurality of second message routers send the data to the plurality of applications of the plurality of users, wherein the application permission module verifies that the plurality of applications are authorized by the plurality of users to receive the data from the first application.

46. The system of claim 38, wherein if the second application is absent on a second computing device, the second message router module prompts the second user to one or more of install and run the second application, wherein the second computing device belongs to the second user.
